(19) United States
(12) Patent Application Publication
(10) Pub. No.: US 2023/0202762 A1
(43) Pub. Date: Jun. 29, 2023

(54) CONVEYOR RACETRACK SYSTEM

(71) Applicant: FLEXLINK AB, Gotebörg (SE)

(72) Inventor: Ulrich KREIMEYER, Pfalzgrafenweiler (DE)

(21) Appl. No.: 17/927,181

(22) PCT Filed: Jun. 3, 2021
(86) PCT No.: PCT/SE2021/050526

§ 371 Date: Nov. 22, 2022

(30) Foreign Application Priority Data
Jun. 4, 2020 (SE) 2050649-9

(51) Int. Cl. B65G 17/32; B65G 23/23; B65G 47/06

(52) U.S. Cl. CPC B65G 17/32; B65G 23/23; B65G 47/06

(57) ABSTRACT

A conveyor system (1) comprising at least one endless chain conveyor (2) and at least one pallet (8) that comprises a magnetic material, where the conveyor system comprises a first loading station (3) and an unloading station (5), where the first loading station (3) comprises a magnet conveyor (6) comprising a linear motor for driving the pallet (8), where the pallet (8) comprises a product holder (9) having at least two holding positions (11, 12, 13, 14), and the magnet conveyor (6) is adapted to stop the pallet (8) at a plurality of positions, in which each holding position (11, 12, 13, 14) is aligned with a delivery position (15) of the first loading station (3). The advantage is that a pallet can be positioned in a plurality of positions at a loading station in a quick and precise manner, allowing for a flexible and quick handling of pallets.

### TECHNICAL FIELD

The present invention relates to a product handling system adapted to handle a batch of products in a conveyor system.

### BACKGROUND ART

Conveying devices, such as those that are used for moving objects between different stations in a factory, usually comprise a conveying track in the form of a belt or a chain. Conveyor belts may be used for straight conveyor systems, where the product is conveyed in a single direction, or when the product is diverted from one straight belt to another straight belt. In conveyor systems where the product is to pass through bends and curves, an endless chain conveyer is of advantage. The conveying tracks can be recessed in a trench with vertical side surfaces. Alternatively, they can be located on the horizontal upper surfaces of the trench or arranged in some other way. The objects to be conveyed are arranged slidably in relation to the conveying tracks, either directly or via carrying means, which are also known as pallets. A pallet may be provided with a specific holder adapted to hold the product in a secure way, such that it does not fall.

A pallet is conveyed along the conveying system, which at least comprises a loading station and an unloading station, and that may also comprise different work stations. At a workstation, the pallet can be stopped such that an operation may be performed on the transported product. In some cases, the product may pass a specific workstation without an operation being performed on the object. When a pallet is stopped, it will glide on the conveyor chain that continues to move and to convey other pallets on the conveyor chain. Such a conveyor system is very suited to transport single products in a relatively slow speed, where the pallets does not have to stop very often.

WO 9742109 A1 shows a carrier device for carrying a plurality of products, where the carrier device can be moved between a plurality of positions in a stepwise manner with a stepper motor driving a conveyor belt. A carrier device is provided with a magnetic material such that a magnet can pull the carrier device towards the conveyor belt, thereby increasing the friction between the conveyor belt and the carrier device such that the carrier device will not slip on the conveyor belt.

In other conveyor systems, where a higher speed is required, and where several stops have to be made, straight conveyor belts with fixed product holders are often used, often referred to as racetrack systems. A racetrack system comprises two conveyor belts, where each belt is provided with a number of fixed product holders, adapted to the number and size of products that are to be conveyed. At a loading station, the racetrack will collect products that may arrive individually on a single conveyor, where each product is loaded in a product holder. When a product is loaded in a product holder, the belt advances to the next product holder such that a new product can be loaded. When all product holders are loaded, the belt advances to the unloading station where the batch of products are unloaded at the same time, e.g. to a carton holding several products in rows and columns.

At the same time, the empty product holder of the other belt is positioned at the loading station, where the empty product holders are loaded with new products. Each belt is driven with a servomotor that allows quick movement and precise stopping position at a high speed. Such a system is well suited when single products are to be grouped in batches, where a batch may be packed in a single package or when several batches are packed in a package.

Such a racetrack system is well adapted for large production runs where the system must not be adapted for different products. Since the product holders are fixed on the conveyor belts, this solution is inflexible, and the product holders can only be changed with great efforts. Such a system is also only adapted for one type of product. Further, there is no possibility to arrange a buffer between the loading station and the unloading station. There is thus room for an improved conveyor system.

### DISCLOSURE OF INVENTION

An object of the invention is therefore to provide an improved conveyor system.

The solution to the problem according to the invention is described in the characterizing part of claim 1. The other claims contain advantageous embodiments and further developments of the conveyor system.

In a conveyor system comprising at least one endless chain conveyor and at least one pallet, where the conveyor system comprises a first loading station and an unloading station, where the first loading station is provided with a first infeed conveyor having a delivery position, where the first loading station comprises a magnet conveyor comprising a linear motor, and where the pallet comprises a magnetic material such that it can be driven by the magnet conveyor at the first loading station, the object of the invention is achieved in that that the pallet comprises a product holder having at least two holding positions where each holding position is adapted to hold a product, and that the magnet conveyor is adapted to stop the pallet at a plurality of positions, in which each holding position of the product holder is aligned with the delivery position of the first infeed conveyor.

By this first embodiment of the conveyor system according to the invention, a conveyor system that allows a pallet to be stopped at several positions at a delivery position at a loading station in a quick and precise manner is provided. With such a conveyor system, a pallet can be loaded with a batch of products from a single, continuous product flow. The products can then be conveyed to an unloading station by a regular conveyor chain, e.g. through bends or curves, and may also be conveyed through a buffer. The pallet can further be conveyed to further loading stations, if two or more different products are to be loaded on the same pallet.

The inventive conveyor system is provided with a linear magnet conveyor at the loading station, and the pallet is provided with magnetic means such that it can be driven by the magnet conveyor. In this way, it is possible to control the movement of the pallet in a quick and very precise manner, such that the pallet can be positioned in exactly defined positions at a delivery position. The movement between each position can further be performed in a quick manner, resembling a racetrack system. The loading station can thus replace a racetrack system when it comes to speed and precision.

A further advantage is that the conveyor system allows for a second loading station, where a different product can be loaded. This may e.g. be the case if a package is to contain two different products in the same package, e.g. a shampoo and a conditioner. The first product is loaded at the first loading station and the second product is loaded at the second loading station. If required, more loading stations may be used for other products. When all products are loaded on the pallet, the pallet is conveyed to an unloading station, where the batch of products are unloaded at the same time, e.g. by a pusher or a robot. Since the pallets are conveyed between the loading station and the unloading station by a regular conveyor chain, the loading station and the unloading station must not be arranged in parallel to each other, which allows for a great flexibility when designing the product flow. Further, the pallets may be diverted to a buffer if the need arises, e.g. if there is a stop at the unloading station due to replacement of the package material.

A pallet is provided with a product holder adapted to hold a plurality of products in parallel. When a new product is to be handled, the product holder may be replaced with another product holder, e.g. by using a quick release, or the pallet may be replaced with another pallet having a different product holder. It is also possible to use pallets with different product holders at the same time, and provide the conveyor system with two different unloading stations, one for each product holder type. In this way, it is e.g. possible to pack products with different batch sizes at the same time.

### BRIEF DESCRIPTION OF DRAWINGS

The invention will be described in greater detail in the following, with reference to the embodiments that are shown in the attached drawings, in which

FIG. 1 shows a conveyor system according to the invention, and

FIG. 2 shows a pallet for the conveyor system according to the invention.

### MODES FOR CARRYING OUT THE INVENTION

The embodiments of the invention with further developments described in the following are to be regarded only as examples and are in no way to limit the scope of the protection provided by the patent claims. References such as longitudinal, horizontal, vertical, right, left etc. refer to directions of a conveyor in normal use.

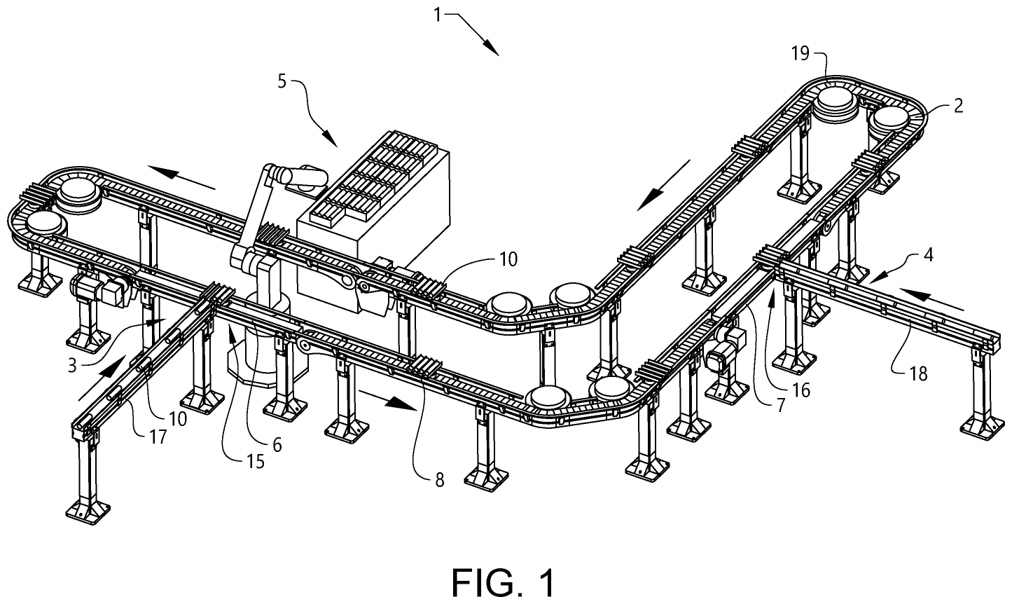

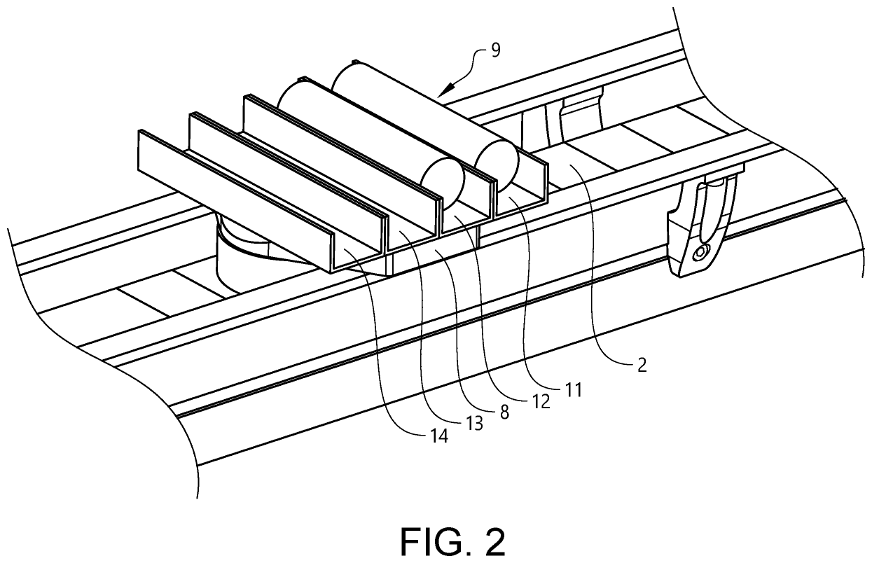

FIG. 1 shows a conveyor system according to the invention, and FIG. 2 shows a pallet to be used in the conveyor system.

The conveyor system 1 comprises at least one chain conveyor 2 of a known type, comprising an endless conveyor chain consisting of a plurality of plastic chain links connected to each other. The conveyor system may comprise one or more chain conveyors, depending on the size and design of the conveyor system. In the shown conveyor system, two chain conveyors are used. Each chain conveyor comprises a drive unit and an idler unit, arranged at each end of the chain conveyor where the conveyor chain changes direction. The conveyor system can be designed in a flexible way and may thus comprise one or more curves 19.

The shown conveyor system further comprises two magnet conveyors, a first magnet conveyor 6 and a second magnet conveyor 7. The first magnet conveyor 6 is arranged at a first loading station 3 and the second magnet conveyor 7 is arranged at a second loading station 4. The magnet conveyors interconnect the two chain conveyors. The conveyor system also comprises an unloading station 5. At the loading stations, products are loaded on a pallet, and the products are forwarded to the unloading station by the chain conveyor, where the products are unloaded into a package of some kind.

The first magnet conveyor 6 is arranged at the first loading 3. At the first loading station, individual products arrive one and one from a production machine of some kind. It may be toothpaste tubes arriving from a toothpaste-filling machine, candy bars arriving from a candy bar wrapping machine, or the like. Common for all products is that they arrive one and one in a continuous flow on a first infeed conveyor 17, and that the products are to be packed in bundles comprising at least two products. The products 10 are thus loaded in a product holder 9 on a pallet 8. The product holder comprises a plurality of holding positions, where each holding position is adapted to hold a product. The products are held in parallel, with the products arranged next to each other. In the shown example, the product holder comprises four holding positions, a first holding position 11, a second holding position 12, a third holding position 13 and a fourth holding position 14. A suitable number of holding positions of a product holder is between two and ten.

The products are conveyed on the first infeed conveyor in a continuous manner. It is thus of great importance that the holding positions of the pallet can be positioned at the delivery position in a quick and precise manner, such that the continuous flow of the first infeed conveyor must not be stopped. Normally, a conveyor of a racetrack system is used to pick up products from a continuous flow. The loading station preferably comprises a sensor that detects when a product arrives at the delivery position and is loaded on the product holder. The detector signal is used to position the pallet at the delivery position when a product arrives. Even if the flow is continuous, the distance between the products may vary.

The first magnet conveyor 6 comprises a linear motor that can drive the pallet in the direction of the product flow of the conveyor system. The linear motor comprises a plurality of magnetic coils that can control the movement of the pallet at the magnet conveyor. The pallet 8 comprises a magnetic material such that it can be driven by the magnet conveyor. The magnetic material may be a magnetic metal or a permanent magnet of some kind. The magnet conveyor can drive and position the pallet with a very high precision and with a high speed. In the shown example, the first magnet conveyor can position the pallet at four positions, where each holding position of the product holder will be aligned with the delivery position 15 of the first loading station 3.

The first magnet conveyor 6 can control several pallets at the same time. It is thus possible to provide a small queue of pallets, e.g. two to four pallets, at the first magnet conveyor such that an empty pallet can be quickly positioned at the delivery position when another pallet has been filled with products. In this way, the continuous flow of the infeed conveyor must not be stopped or slowed down when a new pallet is positioned at the pick-up position.

When a pallet arrives at the first loading station, the pallet is stopped with the first holding position 11 at the delivery position 15, where the first holding position 11 of the product holder is aligned with the delivery position 15 of the first infeed conveyor 17. A product is loaded in the first holding position 11, and the pallet is advanced such that the pallet is stopped with the second holding position 12 at the delivery position 15, such that the second holding position 12 is aligned with the delivery position 15 of the first infeed conveyor 17, and a product is loaded in the second holding position 12. A pallet 8 where the first holding position 11 and the second holding position 12 are loaded with products 10 is shown in FIG. 2. This is repeated until all holding positions of a product holder are filled, in the shown example until the third holding position 13 and the fourth holding position 14 has been loaded with products. The pallet is then forwarded to the chain conveyor for transport to the unloading station, where all products are unloaded at the same time, either to an individual bundle package or to a larger package holding several product bundles.

In the shown example, the conveyor system also comprises a second magnet conveyor 7 arranged at a second loading station 4. The second magnet conveyor 7 is similar or identical to the first magnet conveyor 6, and comprises a linear motor that can drive one or more pallets in the direction of the product flow of the conveyor system. The linear motor comprises a plurality of magnetic coils that can control the movement of the pallet at the magnet conveyor.

The second magnet conveyor can position the pallet with the four holding positions at the delivery position 16, where the holding positions of the product holder are aligned with the delivery position 16 of the second infeed conveyor 18. At the second loading station, products from the second infeed conveyor can be loaded in the product holder. In one example, an empty product holder is filled with products, in the same way as products at the first loading station are loaded in the product holder. In this way, two different products can be handled in the same conveyor system. In another example, a product holder is loaded with both types of products, e.g. a first product in the first and the third holding position, and a second product in the second and fourth holding position. In this case, the second magnet conveyor stops the pallet with the second holding position 12 aligned with the delivery position 16 of the second infeed conveyor 18. When the second holding position is filled, the pallet is advanced such that the fourth holding position 14 is aligned with the delivery position 16 of the second infeed conveyor 18. When the fourth holding position is filled, the product holder is forwarded to the unloading station where all products are unloaded at the same time, into the same package.

In this way, it is possible to mix different products in the same package in an easy and flexible way, which is not possible with a traditional racetrack. The mix may of course vary, depending on the number of holding positions of the product holder and the type of product. It is e.g. possible to offer a new test product to a costumer. When the customer e.g. buys three ordinary products, a fourth test product can be included in the package. It is also possible to group different products in the same package. The products that are loaded in the product holder at different loading stations may have different size or shape, as long as they fit in the holding positions of the product holder. It is also possible to provide the holding positions of the product holder with different shapes and sizes, adapted for products having a different size or shape. In one example, a tube and a bottle are to be included in the same package. A first holding position is then adapted to hold a tube, and a second holding position is adapted to hold a bottle. The tube is loaded at a first loading station, and the bottle is loaded at a second loading station.

The conveyor system may also comprise a buffer, where products can be stored temporarily. The use of a buffer will give some tolerances for problems that may occur at the production of a product, or at the unloading station where the products are packed. The pallets holding products may e.g. enter a buffer when the packaging material at the unloading station must be replaced or replenished. This is also not possible in an ordinary racetrack system. The unloading of products at the unloading station may e.g. be made with a pusher or an industrial robot. At the unloading station, the pallet may be stopped with a conventional mechanical stop. Since only one stop position is required at the unloading station, it is not necessary to use a magnet conveyor to position the pallet.

The invention is not to be regarded as being limited to the embodiments described above, a number of additional variants and modifications being possible within the scope of the subsequent patent claims. The conveyor system may comprise any number of magnet conveyors, and the pallet may have any size or shape.

### REFERENCE SIGNS

1: Conveyor system

2: Endless chain conveyor

3: First loading station

4: Second loading station

5: Unloading station

6: Magnet conveyor of first loading station

7: Magnet conveyor of second loading station

8: Pallet

9: Product holder

10: Product

11: First holding position

12: Second holding position

13: Third holding position

14: Fourth holding position

15: Delivery position of first infeed conveyor

16: Delivery position of second infeed conveyor

17: First infeed conveyor

18: Second infeed conveyor

19: Curve

1-8. (canceled)

9. Conveyor system (1) comprising:
at least one endless chain conveyor (2);
a first loading station (3) and an unloading station (5), the first loading station (3) comprising a first infeed conveyor (17) having a delivery position (15) and a magnet conveyor (6) comprising a linear motor; and
at least one pallet (8) comprising a magnetic material such that it can be driven by the magnet conveyor (6) at the first loading station (3),
wherein:
the pallet (8) further comprises a product holder (9) having at least two holding positions (11, 12, 13, 14) where each holding position is adapted to hold a product (10), and
the magnet conveyor (6) is adapted to stop the pallet (8) at a plurality of positions, in which each holding position (11, 12, 13,14) of the product holder (9) is aligned with the delivery position (15) of the first infeed conveyor (17).

10. Conveyor system according to claim 9, wherein the first infeed conveyor (17) is provided with a continuous flow.

11. Conveyor system according to claim 9, wherein the conveyor system (1) comprises a second loading station (4) comprising a magnet conveyor (7) comprising a linear motor, where the second loading station (4) is provided with a second infeed conveyor (18) having a delivery position (16).

12. Conveyor system according to claim 10, wherein the conveyor system (1) comprises a second loading station (4) comprising a magnet conveyor (7) comprising a linear motor, where the second loading station (4) is provided with a second infeed conveyor (18) having a delivery position (16).

13. Conveyor system according to claim 11, wherein the magnet conveyor (7) at the second loading station (4) is adapted to stop the pallet (8) at a plurality of positions, in which each holding position (11, 12, 13, 14) of the product holder (9) is aligned with the delivery position (16) of the second infeed conveyor (18).

14. Conveyor system according to claim 11, wherein the second infeed conveyor (18) is provided with a continuous flow.

15. Conveyor system according to claim 13, wherein the second infeed conveyor (18) is provided with a continuous flow.

16. Conveyor system according to claim 9, wherein the chain conveyor (2) comprises a at least one curve (23).

17. Conveyor system according to claim 9, wherein the chain conveyor (2) comprises a at least one buffer.

18. Conveyor system according to claim 9, wherein the holding positions (11, 12, 13, 14) of the product holder (9) are adapted for at least two different products.
